(19) United States
(12) Patent Application Publication
(10) Pub. No.: US 2024/0080545 A1
(43) Pub. Date: Mar. 7, 2024

(54) IMAGE CAPTURING CONTROL APPARATUS, IMAGE CAPTURING SYSTEM, IMAGE CAPTURING CONTROL METHOD, AND NON-TRANSITORY COMPUTER READABLE STORAGE MEDIUM

(71) Applicant: CANON KABUSHIKI KAISHA, Tokyo (JP)

(72) Inventor: Etsuya TAKAMI, Kanagawa (JP)

(21) Appl. No.: 18/308,051

(22) Filed: Apr. 27, 2023

(30) Foreign Application Priority Data
May 2, 2022 (JP) 2022-076222

(51) Int. Cl. H04N 23/65; H04N 23/56

(52) U.S. Cl. CPC H04N 23/65; H04N 23/56

(57) ABSTRACT

There is provided with an image capturing control apparatus. A setting unit sets power distributed to each of the plurality of image capturing apparatuses in accordance with a priority for each of the plurality of image capturing apparatuses. A control unit controls the irradiation unit included in each of the plurality of image capturing apparatuses in accordance with the set power.

### BACKGROUND OF THE INVENTION

### Field of the Invention

The present invention relates to an image capturing control apparatus, an image capturing system, an image capturing control method, and a non-transitory computer readable storage medium.

### Description of the Related Art

Conventionally, a modular camera system and an in-vehicle camera system employing a high-speed serial communication system using a serializer and a deserializer have been used. Such a camera system includes a plurality of image capturing units having infrared illumination functions, and is driven by power supply of Power over Ethernet (PoE). In general, the infrared illumination function of the image capturing unit requires large power consumption. Therefore, when the plurality of image capturing units simultaneously use the infrared illumination functions, the total power consumption of the camera system exceeds the maximum power supply of the PoE. As a result, operations of the plurality of image capturing units were stopped and the power to the camera system was cut off.

In view of the above problems, there has been proposed a method that performs control such that the total power consumption of a camera system does not exceed the maximum power supply of a PoE by uniformly limiting predetermined functions of a plurality of image capturing units (Japanese Patent Laid-Open No. 2006-319532). There has been proposed a method of power distribution for driving an optical member of an image capturing unit based on operation information of a plurality of image capturing units (Japanese Patent Laid-Open No. 2011-248164).

### SUMMARY OF THE INVENTION

According to the present invention, it is possible to provide an image capturing control apparatus that captures a clear video even when power supply is limited in a low illumination intensity environment.

The present invention in its one aspect provides an image capturing control apparatus that controls a plurality of image capturing apparatuses, the plurality of image capturing apparatuses including irradiation units that irradiate infrared light, the image capturing control apparatus comprising a hardware processor, and a memory for storing instructions to be executed by the hardware processor, when the instructions stored in the memory are executed by the hardware processor, the image capturing control apparatus functions as setting unit configured to set power distributed to each of the plurality of image capturing apparatuses in accordance with a priority for each of the plurality of image capturing apparatuses, and control unit configured to control the irradiation unit included in each of the plurality of image capturing apparatuses in accordance with the set power.

The present invention in its one aspect provides an image capturing control method that controls a plurality of image capturing apparatuses, the plurality of image capturing apparatuses including irradiation units that irradiate infrared light, the image capturing control method comprising setting power distributed to each of the plurality of image capturing apparatuses in accordance with a priority for each of the plurality of image capturing apparatuses, and controlling the irradiation unit included in each of the plurality of image capturing apparatuses in accordance with the set power.

The present invention in its one aspect provides a non-transitory computer-readable storage medium storing instructions that, when executed by a computer, cause the computer to perform the image capturing control method comprising setting power distributed to each of the plurality of image capturing apparatuses in accordance with a priority for each of the plurality of image capturing apparatuses, and controlling the irradiation unit included in each of the plurality of image capturing apparatuses in accordance with the set power.

Further features of the present invention will become apparent from the following description of exemplary embodiments (with reference to the attached drawings).

### BRIEF DESCRIPTION OF THE DRAWINGS

FIG. 1 is a diagram illustrating an example of a configuration of an image capturing system.

FIG. 2 is a flowchart explaining processing of power distribution by an image capturing control apparatus according to a first embodiment.

FIG. 3 is a flowchart explaining processing of power distribution by the image capturing control apparatus according to a second embodiment.

FIG. 4A is a diagram for explaining a schedule of turning on and off illumination units according to the second embodiment.

FIG. 4B is a diagram for explaining a moving image generation method according to the schedule of turning on and off the illumination units of FIG. 4A and FIG. 4C.

FIG. 4C is a diagram for explaining a schedule of turning on and off the illumination units according to the second embodiment.

FIG. 5 is a diagram illustrating overlapping regions formed by two infrared illuminations according to a third embodiment.

FIG. 6 is a block diagram illustrating an example of a functional configuration of an image capturing apparatus.

FIG. 7 is a block diagram illustrating an example of a functional configuration of the image capturing control apparatus.

FIG. 8 is a diagram for explaining a method of distributing excess power.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

### First Embodiment

An image capturing control apparatus sets power distributed to each of a plurality of image capturing apparatuses according to a priority set to each of the plurality of image capturing apparatuses. The image capturing control apparatus controls an output of an irradiation unit included in each of the plurality of image capturing apparatuses according to the set power.

The image capturing control apparatus can be connected to or mounted on various devices having a function of capturing a moving image. Examples of the device having the function of capturing a moving image include a network camera, a video camera, a still camera, a drive recorder, an in-vehicle camera, a mobile phone (for instance, a smartphone), and a mobile information terminal. Further, in the first embodiment, image capturing functions of some image capturing apparatuses are limited based on a priority of turning on infrared illumination of each of the image capturing apparatuses such that the total power consumption of all of the image capturing apparatuses is within the maximum power supply of a PoE. In the first embodiment, a method of continuing capturing moving images while the infrared illumination is turned on by distributing excess power obtained by limiting the image capturing functions of some image capturing apparatuses to the other image capturing apparatuses is provided. Hereinafter, an embodiment will be described with reference to the accompanying drawings, taking as an example of a case where a network camera is connected to the image capturing control apparatus of the present invention.

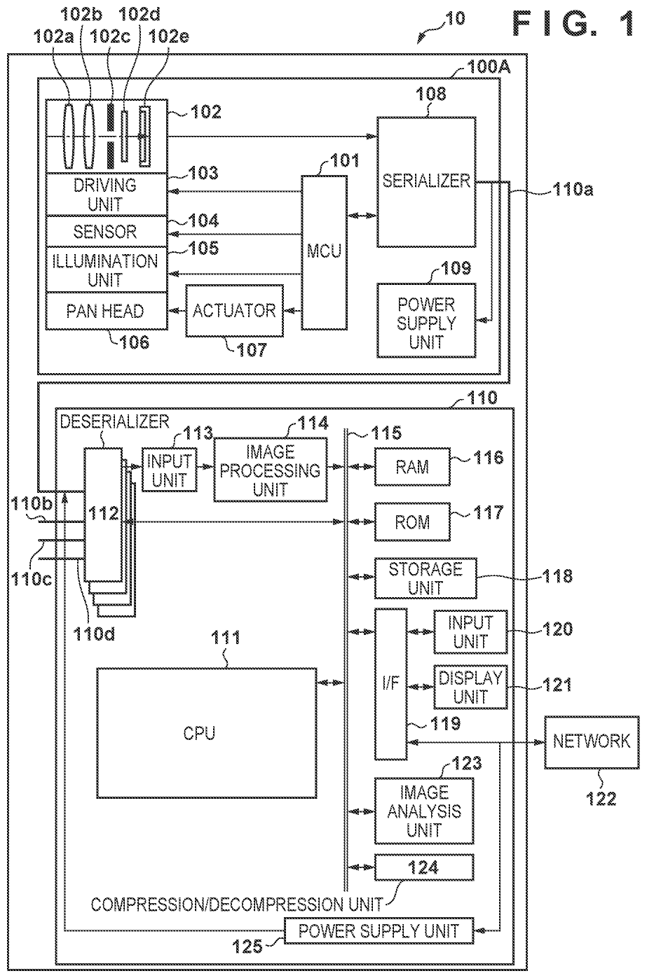

FIG. 1 is a diagram illustrating an example of a configuration of an image capturing system.

An image capturing system 10 is, for instance, a monitoring camera system with infrared illumination, which captures a clear video in a low illumination intensity environment. The image capturing system 10 includes an image capturing apparatus 100A, image capturing apparatuses 100B to 100D (not illustrated), an image capturing control apparatus 110, and a network 122. The image capturing apparatus 100A and the image capturing apparatuses 100B to 100D (not illustrated) are connected to the image capturing control apparatus 110 via cables 110a to 110d. In the present embodiment, the number of image capturing apparatuses connected to the image capturing control apparatus 110 is four, but is not limited to this. Further, each of the image capturing apparatuses may include the image capturing control apparatus 110.

The image capturing apparatus 100A is a camera that captures an image of a subject, and is, for instance, a network camera. The image capturing apparatus 100A includes an MCU 101, an image capturing unit 102, a driving unit 103, a sensor 104, an illumination unit 105, a pan head 106, an actuator 107, a serializer 108, and a power supply unit 109. Since the image capturing apparatuses 100B to 100D have the same configuration as that of the image capturing apparatus 100A, description of the image capturing apparatuses 100B to 100D is omitted.

The MCU 101 is a microprocessor.

The image capturing unit 102 includes a zoom lens 102a, a focus lens 102b, a diaphragm 102c, an infrared cut filter 102d, and an image capturing element 102e.

The zoom lens 102a and the focus lens 102b are moved along an optical axis by the driving unit 103.

The diaphragm 102c is driven by the driving unit 103 to adjust an amount of light passing therethrough.

The infrared cut filter 102d is driven by the driving unit 103. The infrared cut filter 102d is inserted when sufficient illuminance can be obtained. At this time, the image capturing element 102e receives light that does not contain infrared light. The infrared cut filter 102d is removed when sufficient illuminance cannot be obtained. At this time, the image capturing element 102e receives light containing infrared light.

The image capturing element 102e is, for instance, an image sensor. The image capturing element 102e photoelectrically converts light that has passed through the zoom lens 102a, the focus lens 102b, the diaphragm 102c, and the infrared cut filter 102d to generate an analog image signal. Amplification processing is performed on the analog image signal by sampling processing, such as correlated double sampling, and it is transmitted to the serializer 108.

The driving unit 103 drives each unit of the image capturing unit 102.

The sensor 104 is a sensor that detects displacement of acceleration, angular velocity, and azimuth of the image capturing unit 102 at a predetermined sampling rate. Examples of the sensor 104 include an acceleration sensor, an angular velocity sensor, a geomagnetic sensor, an illuminance sensor, and a temperature sensor. The sensor 104 transmits a result of detecting various states of the image capturing unit 102 to the MCU 101.

The illumination unit 105 is a Light Emitting Diode (LED) that irradiates a subject with infrared light. When the infrared cut filter 102d is removed, the illumination unit 105 irradiates the subject with infrared light to capture a clear video even in the dark (0 1×).

The pan head 106 includes a pan driving unit and a tilt driving unit.

The pan driving unit includes a bottom case and a turntable. When the turntable rotates in a horizontal direction, the image capturing unit 102 is panned. The pan driving unit can rotate from −175 degrees to +175 degrees in the left-right direction.

The tilt driving unit includes a strut provided on the turntable and the image capturing unit 102, and the image capturing unit 102 rotates in a vertical direction. The tilt driving unit can rotate from 0 degrees in the horizontal direction to 90 degrees in the right above direction.

The actuator 107 drives the pan driving unit and the tilt driving unit of the pan head 106. The image capturing unit 102 rotates in the horizontal and vertical directions by driving the pan head 106. As a result, the image capturing unit 102 can capture the subject while changing an image capturing direction.

The serializer 108 converts an image signal into a predetermined high-speed serial signal and transmits the converted signal to a deserializer 112.

The power supply unit 109 receives power supplied from the deserializer 112 described below.

The image capturing control apparatus 110 is an apparatus that controls capturing images by the image capturing apparatuses 100A to 100D and supplies power to the image capturing apparatuses 100A to 100D. The image capturing control apparatus 110 is, for instance, a PoE-compliant power supply switching hub. The image capturing control apparatus 110 includes a CPU 111, the deserializer 112, an input unit 113, an image processing unit 114, a bus 115, a RAM 116, a ROM 117, a storage unit 118, an I/F 119, and an input unit 120. The image capturing control apparatus 110 also includes a display unit 121, an image analysis unit 123, and a compression/decompression unit 124.

The CPU 111 is a device that controls each unit of the image capturing control apparatus 110.

The deserializer 112 converts the high-speed serial signal into a predetermined image signal and transmits the image signal to the input unit 113.

The input unit 113 transmits a digital image signal received from an A/D conversion unit (not illustrated) to the image processing unit 114.

The image processing unit 114 performs image processing on the digital image signal received from the input unit 113 based on sensitivity information at the time of capturing an image output from the image capturing element 102e, for instance, Automatic Gain Control (AGC) gain or International Organization for Standardization (ISO) sensitivity. Thereafter, the image processing unit 114 stores the digital image signal after the image processing in the RAM 116.

Here, the image processing includes optical black processing, defective pixel correction processing, aberration correction, light falloff at edge correction, gain processing, white balance processing, RGB interpolation processing, dynamic range expansion processing, and color difference signal conversion. The image processing includes offset processing, gamma correction processing, noise reduction processing, contour correction processing, color tone correction processing, light source type determination processing, and scaling processing.

The RAM 116 is a volatile memory, such as an SRAM and a DRAM.

The ROM 117 is a nonvolatile memory, such as an EEPROM and a flash memory.

The storage unit 118 is a device that stores various types of data and includes, for instance, a Hard Disk Drive (HDD), a Solid State Drive (SSD), and an embedded Multi Media Card (eMMC).

A program for achieving the functions of the present embodiment and data used during execution of the program are stored in the ROM 117 or the storage unit 118. The program and the data are transmitted to the RAM 116 under the control by the CPU 111. Each function of the image capturing control apparatus 110 is achieved by executing the program by the CPU 111.

The I/F 119 is a device that relays input or output signals. The I/F 119 transmits the input from the input unit 120 to the CPU 111.

The input unit 120 is a device that accepts an operation of a user. The input unit 120 is, for instance, an operation key including a release switch and a power switch, a directional pad, a joystick, a touch panel, a keyboard, or a pointing device (for instance, a mouse).

The display unit 121 is a device that displays various types of data and is, for instance, a Liquid Crystal Display (LCD). The display unit 121 displays an image or an operation menu temporarily stored in the RAM 116.

The network 122 is connected to the image capturing control apparatus 110 via the I/F 119. The network 122 is, for instance, a wired LAN.

The image analysis unit 123 performs image analysis on images captured by the image capturing apparatuses 100A to 100D or images stored in advance in the storage unit 118. The image analysis includes, for instance, face detection, person detection, moving subject detection, passage detection, congestion detection, track detection, and abandonment and carry-away detection. The image analysis unit 123 transmits the image analysis result to the CPU 111.

The compression/decompression unit 124 performs compression processing on the image under the control by the CPU 111 to generate compressed data. The compressed data is output to the display unit 121 and the network 122. The compression/decompression unit 124 generates non-compressed data by performing decompression processing in a predetermined format on the compressed data in the storage unit 118. For instance, the compression/decompression unit 124 performs compression/decompression processing on a still image by a compression method compliant with the JPEG standard. The compression/decompression unit 124 performs compression/decompression processing on a moving image by a method compliant with the standards of MOTION-JPEG, MPEG2, AVC also known as H.264, and HEVC also known as H.265.

A power supply unit 125 is supplied with power from the network 122 (wired LAN) using the PoE. Then, the power supply unit 125 distributes the received power into power to be supplied to the image capturing apparatus 100A and power to be supplied to the image capturing control apparatus 110. Note that while the power supply method using the PoE will be described in the present embodiment, the power supply method is not limited thereto. The power of the image capturing apparatus 100A is supplied to the power supply unit 109 together with communication between the serializer 108 and the deserializer 112.

The cable 110a is a coaxial cable and connects the serializer 108 and the deserializer 112. The cables 110b to 110d have the same function as the cable 110a.

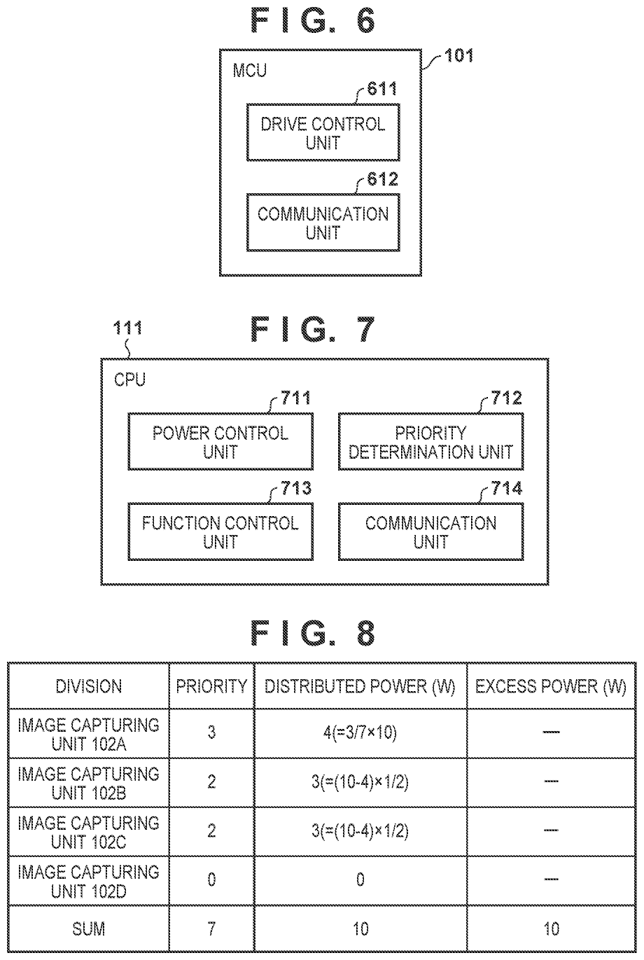

Here, FIG. 6 is a block diagram illustrating an example of a functional configuration of the image capturing apparatus. The image capturing apparatuses 100A to 100D have functions illustrated in FIG. 6.

The MCU 101 includes a drive control unit 611 and a communication unit 612.

The drive control unit 611 controls the output of the illumination unit 105.

The communication unit 612 controls data transmission and reception between the respective units of the image capturing apparatuses 100A to 100D and between the image capturing apparatuses 100A to 100D and the image capturing control apparatus 110.

FIG. 7 is a block diagram illustrating an example of a functional configuration of the image capturing control apparatus.

The CPU 111 includes a power control unit 711, a priority determination unit 712, a function control unit 713, and a communication unit 714.

The power control unit 711 calculates power distributed to the illumination unit 105 of each of the image capturing apparatuses 100A to 100D based on the priority of turning on the illumination unit 105 by the priority determination unit 712. At this time, the power control unit 711 may perform setting such that a reduction rate of the power distributed to the illumination unit 105 of the image capturing apparatus having the high priority is reduced. The power control unit 711 may calculate the power distributed to the image capturing apparatuses 100A to 100D based on the “priority of capturing an image” of each of the image capturing apparatuses 100A to 100D. In this case, the user sets the priority of capturing an image of each of the image capturing apparatuses in consideration of the environments of the installation locations of the image capturing apparatuses 100A to 100D in advance.

The priority determination unit 712 determines priorities (priority orders) for turning on the illumination units 105 of the image capturing apparatuses 100A to 100D based on a predetermined condition. The predetermined condition refers to whether the image capturing apparatus has a high priority of capturing an image set in advance by the user, whether the image capturing apparatus captures a moving image in which a subject of interest is captured, and whether the image capturing apparatus includes the illumination unit 105. Note that the predetermined condition is not limited to these.

The function control unit 713 calculates lighting intensity of the illumination unit 105 of each of the image capturing apparatuses based on the powers distributed to the image capturing apparatuses 100A to 100D. The function control unit 713 transmits the lighting intensities of the illumination units 105 to the drive control units 611 of the image capturing apparatuses 100A to 100D.

The communication unit 714 controls data transmission and reception between the respective units of the image capturing control apparatus 110 and between the image capturing apparatuses 100A to 100D and the image capturing control apparatus 110.

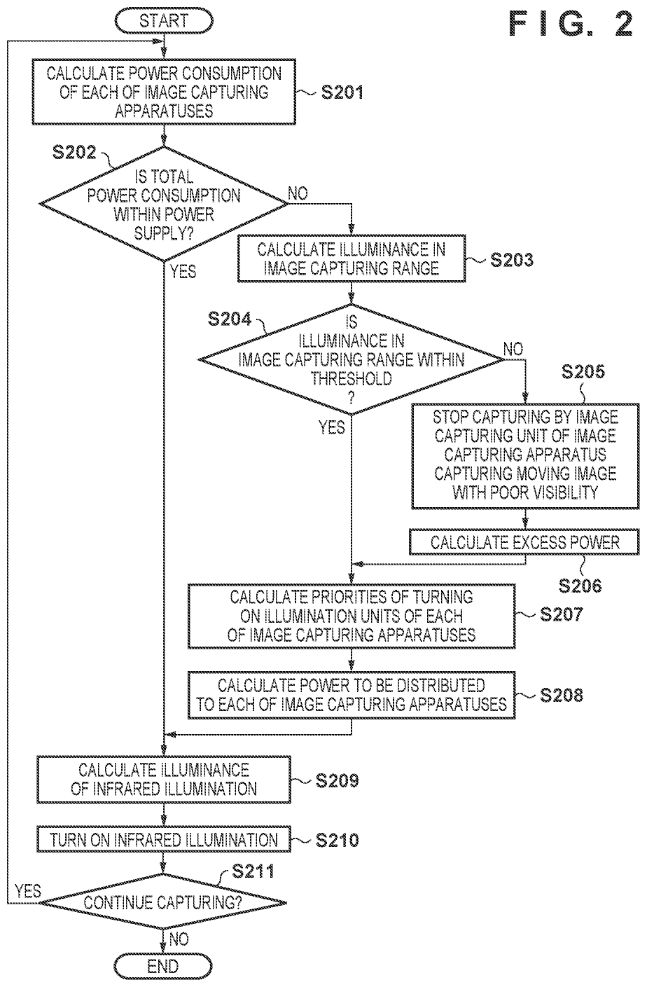

FIG. 2 is a flowchart explaining processing of power distribution by the image capturing control apparatus according to the first embodiment. The processing corresponding the flowchart can be achieved by, for instance, executing a corresponding program (stored in the ROM 117 or storage unit 118) by the CPU 111 operating in the image capturing control apparatus 110.

In the first embodiment, the image capturing function of the image capturing apparatus is limited based on the priority of turning on the illumination unit 105 assigned to each of the image capturing apparatuses such that the total power consumption of the image capturing apparatus 100A to the image capturing apparatus 100D does not exceed the maximum power supply of the PoE. In the first embodiment, when the total power consumption of the image capturing apparatus 100A to the image capturing apparatus 100D is within the maximum power supply of the PoE, the output of the illumination unit 105 of each of the image capturing apparatuses is maintained.

In S201, the power control unit 711 receives a lighting request (for instance, requested power) of the illumination units 105 of the image capturing apparatuses 100A to 100D from the function control unit 713. The power control unit 711 calculates the power consumption of each of the image capturing apparatuses based on the lighting intensities of the illumination units 105 included in the lighting requests of the illumination units 105 of the image capturing apparatuses 100A to 100D.

In S202, the power control unit 711 sums the power consumptions of the image capturing apparatuses 100A to 100D (excluding the power consumptions of the illumination units 105) to calculate the total power consumption. The power control unit 711 determines whether the total power consumption is within the maximum power supply of the PoE. When the power control unit 711 determines that the total power consumption is within the maximum power supply of the PoE (Yes in S202), the processing proceeds to S209. When the power control unit 711 determines that the total power consumption is not within the maximum power supply of the PoE (No in S202), the processing proceeds to S203.

In S203, the function control unit 713 acquires the illuminance in the image capturing range of the image capturing unit 102 of each of the image capturing apparatuses via the sensor 104. Alternatively, the function control unit 713 may acquire the illuminance in the image capturing range of the image capturing unit 102 calculated from the moving image by the image processing unit 114 or the image analysis unit 123 of each of the image capturing apparatuses.

In S204, the function control unit 713 determines, of each of the image capturing apparatuses, whether the illuminance in the image capturing range of the image capturing unit 102 is within a threshold (for instance, the minimum subject illuminance). Here, the minimum subject illuminance refers to a minimum illuminance (degree of brightness) required for the image capturing apparatus to capture a subject. When the function control unit 713 determines that the illuminance in the image capturing range of the image capturing unit 102 is within the threshold (Yes in S204), the processing proceeds to S207. When the function control unit 713 determines that the illuminance in the image capturing range of the image capturing unit 102 is not within the threshold (No in S204), the processing proceeds to S205. Note that the function control unit 713 may use a parameter other than the illuminance in the image capturing range of the image capturing unit 102 to determine the image capturing apparatus that captures a moving image with poor visibility in a low illumination intensity environment. In addition, the function control unit 713 may determine whether to stop capturing an image by the image capturing unit 102 based on whether the subject of interest is captured in the image captured by the image capturing unit 102.

In S205, the function control unit 713 performs control to stop capturing an image by the image capturing unit 102 of the image capturing apparatus determined (selected) in S204. In the present embodiment, since the image capturing unit 102 to stop capturing an image does not include the illumination unit 105, a moving image with poor visibility is captured in a low illumination intensity environment.

In S206, the power control unit 711 calculates excess power based on a difference between the total power consumption (excluding the power consumptions of the illumination units 105) obtained by subtracting the power consumption of the image capturing unit 102 that has stopped capturing an image in S205 from the total power consumption calculated in S202 and the maximum power supply of the PoE. Note that the excess power refers to spare power that can be used by the image capturing system 10.

In S207, the priority determination unit 712 acquires information on the image capturing apparatus having the high priority of capturing an image set in advance by the user and information on the image capturing apparatus that captures a moving image capturing a subject of interest detected by image analysis. The priority determination unit 712 calculates the priorities of turning on the illumination units 105 of the image capturing apparatuses 100A to 100D.

First, it is assumed that a basic point of priority assigned to each of the image capturing apparatuses is one point. Next, the priority determination unit 712 calculates the priority of turning on the illumination unit 105 of the image capturing apparatus having the high priority of capturing an image set in advance by the user as “+2 points.” The priority determination unit 712 calculates the priority of turning on the illumination unit 105 of the image capturing apparatus capturing the moving image that captures the subject of interest detected by image analysis as “+1 point.” The priority determination unit 712 calculates the priority of turning on the illumination unit 105 of the image capturing apparatus that does not include the illumination unit 105 as “−1 point.” Thus, the priority of turning on the illumination unit 105 of each of the image capturing apparatuses is digitized. Note that the expression method of the priority of turning on the illumination unit 105 is not limited to the above-described method.

In S208, the power control unit 711 distributes the excess power calculated in S206 to each of the image capturing apparatuses based on a ratio obtained from the priority of turning on the illumination unit 105 of each of the image capturing apparatuses.

Here, FIG. 8 is a diagram for explaining the method of distributing excess power.

For instance, it is assumed that the excess power is 10 W, and the power required for turning on all of the illumination units 105 is 4 W. It is also assumed that the priority of turning on the illumination unit 105 of the image capturing apparatus 100A is “3.” It is assumed that the priorities of turning on the illumination units 105 of the image capturing apparatus 100B and the image capturing apparatus 100C are “2.” It is assumed that the priority of turning on the illumination unit 105 of the image capturing apparatus 100D is “0.” Here, the total priority refers to a priority obtained by summing the priorities of turning on the illumination units 105 of the image capturing apparatuses 100A to 100D. The total priority calculated under the above conditions is 7 (=3+2+2+0). Hereinafter, the priority of turning on the illumination unit 105 is referred to as “priority” for short.

The power control unit 711 calculates about 4 W (=10 W×3/7) obtained based on the ratio (=3/7) of the priority 3 of the image capturing apparatus 100A to the total priority 7 and the excess power 10 W as power distributed to the image capturing apparatus 100A. In this case, since the image capturing apparatus 100A can secure the full power 4 W required to turn on the illumination unit 105, all of the illumination units 105 can be turned on.

Next, the power control unit 711 calculates the total priority 4 by subtracting the priority 3 of the image capturing apparatus 100A from the total priority 7. The power control unit 711 calculates the excess power 10 W by subtracting the power 4 W distributed to the image capturing apparatus 100A from the excess power 6 W.

The power control unit 711 calculates 3 W (6 W×0.5) obtained based on the ratio 0.5 (=2/4) of the priority 2 of the image capturing apparatus 100B and the image capturing apparatus 100C to the total priority 4 and the excess power 6 W (=10−4) as power distributed to each of the image capturing apparatuses. As a result, the image capturing apparatus 100B and the image capturing apparatus 100C can secure 3 W among the power 4 W required to turn on the illumination units 105, and thus some of the illumination units 105 can be turned on.

Since the priority of the image capturing apparatus 100D is 0, the power control unit 711 does not distribute the excess power to the image capturing apparatus 100D. As described above, in the present embodiment, the power distributed to each of the image capturing apparatuses is obtained based on the priority of turning on the illumination unit 105 of each of the image capturing apparatuses, but the method is not limited to the above-described method. The description goes back to the flowchart in FIG. 2.

In S209, the function control unit 713 calculates the lighting intensity of the illumination unit 105 of each of the image capturing apparatuses based on the power distributed in S208, and transmits the calculated lighting intensity to the drive control unit 611.

In S210, the drive control unit 611 turns on the illumination unit 105 of each of the image capturing apparatuses based on the lighting intensity of the illumination unit 105 of each of the image capturing apparatuses calculated in S209.

In addition, when the total power consumption of the image capturing system 10 exceeds the maximum power supply of the PoE and turning on the illumination units 105 of the image capturing apparatuses 100A to 100D is limited, the display unit 121 performs the following notification. For instance, the display unit 121 uses a text overlay function to display, on a screen (not illustrated) of an external apparatus, an image in which a message indicating output limitation of the illumination unit 105 is superimposed on a moving image captured by each of the image capturing apparatuses. Accordingly, the user can recognize the output limitation of the illumination unit 105. Note that the present embodiment is not limited to the above-described notification method.

In S211, the CPU 111 determines whether to continue capturing an image by the image capturing system 10 based on an instruction input to the input unit 120 by the user. When the CPU 111 determines to continue capturing an image by the image capturing system 10 (Yes in S211), the processing returns to S201. When the CPU 111 determines that the image capturing system 10 does not continue capturing an image (No in S211), the processing ends.

As described above, according to the first embodiment, the excess power is distributed to the illumination unit of each of the image capturing apparatuses based on the priority of turning on the illumination unit of each of the image capturing apparatuses. This makes it possible to capture a moving image with high visibility even when power supply is limited in a low illumination intensity environment.

### Second Embodiment

In the second embodiment, lighting of the illumination unit of each of the image capturing apparatuses is switched at predetermined time intervals. In this case, the second embodiment provides a method of providing a moving image (video) captured by the image capturing apparatus in which the illumination unit is turned on by controlling a frame rate at which the moving image is delivered. In the second embodiment, only differences from the first embodiment will be described.

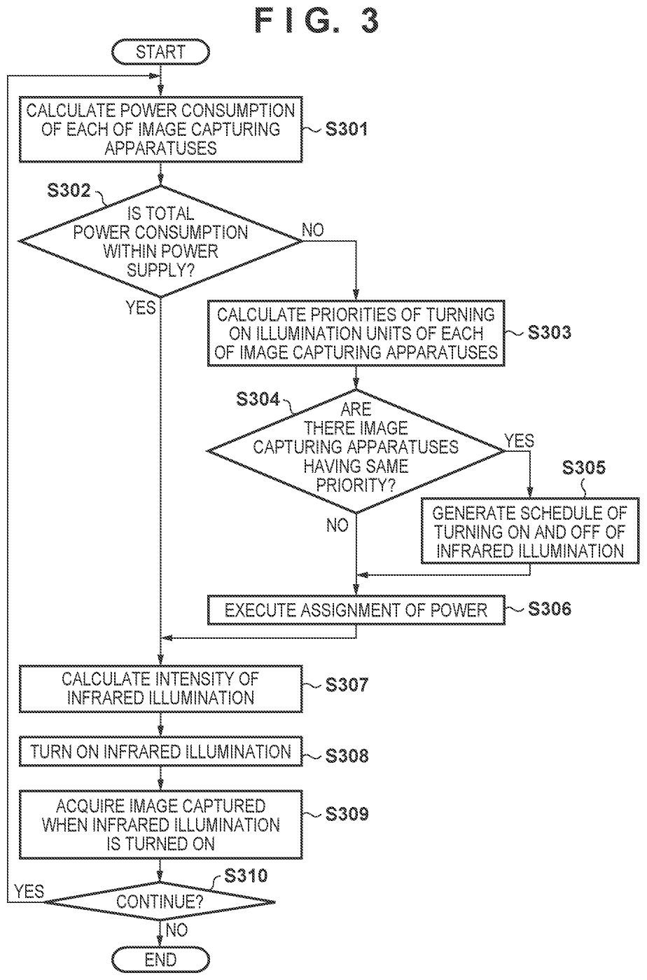

FIG. 3 is a flowchart explaining processing of power distribution by the image capturing control apparatus according to the second embodiment. The processing corresponding the flowchart can be achieved by, for instance, executing a corresponding program (stored in the ROM 117 or storage unit 118) by the CPU 111 operating in the image capturing control apparatus 110.

Processing in S301 is same as processing of S201 in FIG. 2, and thus explanation thereof will be omitted.

Processing in S302 is same as processing of S202 in FIG. 2, and thus explanation thereof will be omitted.

Processing in S303 is same as processing of S207 in FIG. 2, and thus explanation thereof will be omitted.

In S304, the function control unit 713 determines whether there are two or more image capturing apparatuses having the same priority based on the result of the priorities calculated in S203. When the function control unit 713 determines that the two or more image capturing apparatuses having the same priority are present (Yes in S304), the processing proceeds to S305. When the function control unit 713 determines that the two or more image capturing apparatuses having the same priority are not present (No in S304), the processing proceeds to S306.

In S305, the function control unit 713 schedules the order of turning on and off and the interval of turning on the illumination unit 105 of each of the image capturing apparatuses.

In S306, the power control unit 711 calculates the power distributed to each of the image capturing apparatuses based on the priority calculated in S303 and the schedule created in S305.

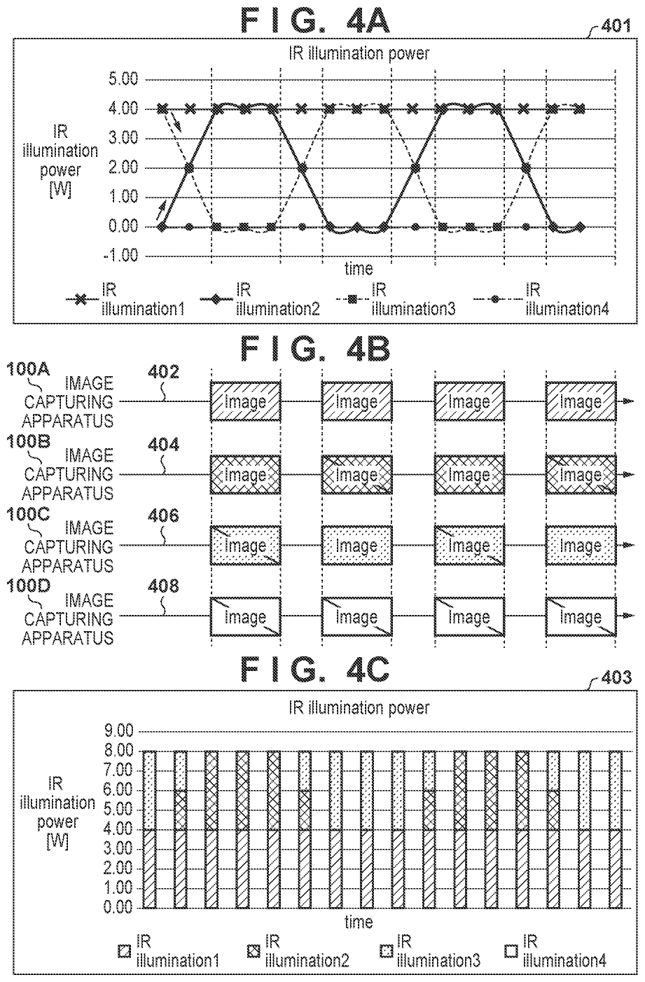

Here, FIG. 4A and FIG. 4C are diagrams for explaining the schedule of turning on and off the illumination units according to the second embodiment. In FIG. 4A to FIG. 4C, the excess power is 8 W.

A graph 401 in FIG. 4A and a graph 403 in FIG. 4C indicate the power distributed to the illumination unit 105 of each of the image capturing apparatuses in time series. In the graph 401 and the graph 403, the horizontal axis represents time and the vertical axis represents power consumption (W) of the illumination units 105. The time on the horizontal axis represents the output timing of the illumination unit 105 of each of the image capturing apparatuses. The power distributed to the illumination unit 105 of the image capturing apparatus 100A having the highest priority 3 in FIG. 8 is represented by 4 W in the graph 401.

Next, the image capturing apparatus 100B and the image capturing apparatus 100C having the same priority level 2 in FIG. 8 sequentially turn on and off the illumination units 105 to share the remaining excess power 4 W by half. In addition, since the image capturing apparatus 100D having the priority 0 in FIG. 8 does not include the illumination unit 105, the power distributed to the image capturing apparatus 100D is 0 W.

As described above, it is possible to suppress the total power consumption of the image capturing system 10 by alternately (intermittently) switching turning on and off the illumination units 105. Note that the method of power distribution based on the priority is not limited in the present embodiment.

Processing in S307 is same as processing of S209 in FIG. 2, and thus explanation thereof will be omitted.

Processing in S308 is same as processing of S210 in FIG. 2, and thus explanation thereof will be omitted.

In S309, the CPU 111 acquires a moving image captured by the image capturing apparatus in which the illumination unit 105 turns on based on the schedule created in S305. On the other hand, the CPU 111 limits the frame rate of the moving image captured by the image capturing apparatus in which turning on the illumination unit 105 is limited, and records, outputs, or delivers the limited moving image. The CPU 111 does not limit the frame rate of the moving image when there is no schedule created in S305.

Here, FIG. 4B is a diagram for explaining a moving image generation method according to the schedule of turning on and off the illumination units of FIG. 4A and FIG. 4C. A moving image 402 to a moving image 408 in FIG. 4B are captured by the image capturing apparatus 100A to the image capturing apparatus 100D. The CPU 111 generates the moving image 402 without limiting the frame rate as the illumination unit 105 of the image capturing apparatus 100A always turns on.

The illumination units 105 of the image capturing apparatus 100B and the image capturing apparatus 100C sequentially turn on and off. Therefore, the CPU 111 acquires only an image captured while the illumination units 105 of the image capturing apparatus 100B and the image capturing apparatus 100C turn on, and does not acquire an image captured while the illumination units 105 turn off. Accordingly, the CPU 111 generates a moving image 404 and a moving image 406 by limiting the frame rate.

In the graph 401 of FIG. 4A, the illumination unit 105 of the image capturing apparatus 100B and the illumination unit 105 of the image capturing apparatus 100C alternately turn on and off. Therefore, the CPU 111 acquires images captured by the image capturing apparatus 100B and the image capturing apparatus 100C corresponding to the cycle of turning on the illumination unit 105. As a result, the CPU 111 generates the moving image 404 and the moving image 406 at the frame rate that is half of the frame rate when the frame rate is not limited.

The CPU 111 does not generate a moving image 408 as the image capturing apparatus 100D does not include the illumination unit 105.

In S310, the CPU 111 determines whether to continue capturing an image by the image capturing system 10 based on an instruction input to the input unit 120 by the user. When the CPU 111 determines to continue capturing an image by the image capturing system 10 (Yes in S211), the processing returns to S201. When the CPU 111 determines that the image capturing system 10 does not continue capturing an image (No in S211), the processing ends.

Note that the methods of switching turning on and off the illumination unit 105 and limiting the frame rate in the present embodiment are not limited to the above-described methods. In the second embodiment, the above-described methods are not applied only when there are two or more image capturing apparatuses having the same priority.

As described above, according to the second embodiment, turning on and off the illumination units of the image capturing apparatuses is controlled at predetermined time intervals. In the second embodiment, a moving image with good visibility can be acquired by limiting the frame rate and acquiring only a video captured while the illumination unit turns on.

### Third Embodiment

The third embodiment performs determination on two or more image capturing apparatuses having image capturing ranges, any one of which includes an overlapping region formed by the respective illumination units of the two or more image capturing apparatuses irradiating infrared illumination. The third embodiment provides a method of securing excess power by limiting turning on the illumination unit of the determined image capturing apparatus.

In S207 of FIGS. 2 and S303 of FIG. 3, the priority determination unit 712 acquires the image capturing range of each of the image capturing apparatuses and an irradiation range in which the illumination unit 105 of each of the image capturing apparatuses irradiates infrared illumination. Then, the priority determination unit 712 calculates an “overlapping range” in which an irradiation range in which the illumination unit 105 of one image capturing apparatus irradiates infrared illumination and an irradiation range in which the illumination unit 105 of the other image capturing apparatus irradiates infrared illumination overlap in the image capturing range of the one image capturing apparatus.

The image capturing range of each of the image capturing apparatuses and the irradiation range in which the illumination unit 105 of each of the image capturing apparatuses irradiates infrared illumination, which are product-specific information, are registered in the ROM 117 and the MCU 101 in advance. The priority determination unit 712 acquires the image capturing range of each of the image capturing apparatuses and the irradiation range in which the illumination unit 105 of each of the image capturing apparatuses irradiates infrared illumination from the ROM 117 and the MCU 101.

When the overlapping range overlaps with a part of the image capturing range of the image capturing apparatus, the priority determination unit 712 sets the priority for turning on the illumination unit 105 of the image capturing apparatus to +1 to +2 points. In addition, when the overlapping range overlaps the entire image capturing range of the image capturing apparatus, the priority determination unit 712 sets the priority for turning on the illumination unit 105 of the image capturing apparatus to 0 points and limits turning on the illumination unit 105.

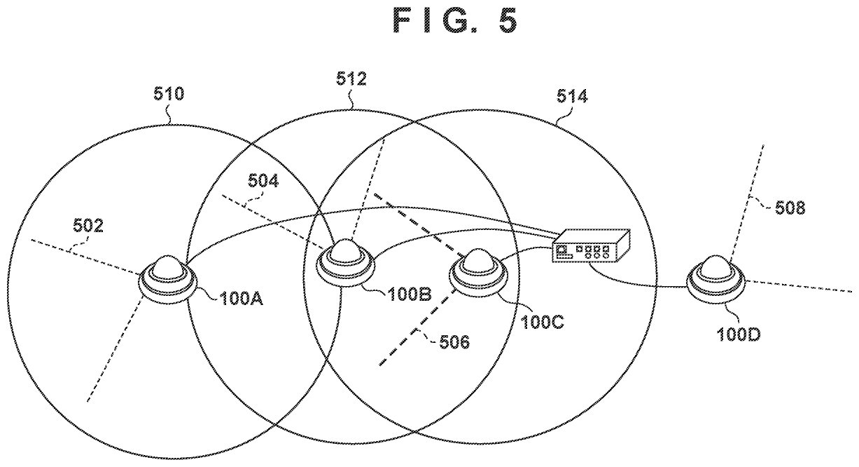

FIG. 5 is a diagram illustrating the overlapping regions formed by two infrared illuminations.

An image capturing range 502 is an image capturing range of the image capturing apparatus 100A. An irradiation range 510 is a range in which the illumination unit 105 of the image capturing apparatus 100A irradiates infrared illumination.

An image capturing range 504 is an image capturing range of the image capturing apparatus 100B. An irradiation range 512 is a range in which the illumination unit 105 of the image capturing apparatus 100B irradiates infrared illumination.

An image capturing range 506 is an image capturing range of the image capturing apparatus 100C. An irradiation range 514 is a range in which the illumination unit 105 of the image capturing apparatus 100C irradiates infrared illumination.

An image capturing range 508 is an image capturing range of the image capturing apparatus 100D.

Here, the entire overlapping range (the overlapping portion of the two circles) in which the irradiation range 512 overlaps with the irradiation range 514, which overlaps with the image capturing range 506. The priority determination unit 712 determines the priority of turning on the illumination unit 105 of the image capturing apparatus 100C as +1 to +2 points. That is, even when the illumination unit 105 of the image capturing apparatus 100C does not irradiate infrared illumination, the image capturing range 506 is covered by the irradiation range 512 of the illumination unit 105 of the image capturing apparatus 100B. Therefore, the priority determination unit 712 performs control such that the illumination unit 105 of the image capturing apparatus 100C is not turned on.

On the other hand, a part of the overlapping range (the overlapping portion of the two circles) in which the irradiation range 510 overlaps with the irradiation range 512, which overlaps with the image capturing range 504. Here, the priority determination unit 712 determines the priority of turning on the illumination unit 105 of the image capturing apparatus 100B as +1 to +2 points. That is, the image capturing apparatus 100B needs to turn on the illumination unit 105 of the image capturing apparatus 100B to secure the illuminance of the image capturing range 504.

Furthermore, a part of the overlapping range (the overlapping portion of the two circles) in which the irradiation range 510 overlaps with the irradiation range 512, which overlaps with the image capturing range 502. Here, the priority determination unit 712 determines the priority of turning on the illumination unit 105 of the image capturing apparatus 100A as +1 to +2 points. That is, the image capturing apparatus 100A needs to turn on the illumination unit 105 of the image capturing apparatus 100A to secure the illuminance of the image capturing range 502.

In the third embodiment, the priority of turning on the illumination unit is determined based on the degree of overlap between the overlapping range formed by two infrared illuminations and the image capturing range of the image capturing apparatus, but the present invention is not limited to this.

As described above, according to the third embodiment, turning on the illumination units of the image capturing apparatuses is limited based on the degree of overlap between the overlapping range of infrared illumination formed by two or more image capturing apparatuses irradiating infrared illuminations and the image capturing range of the image capturing apparatus. Accordingly, it is possible to save the power consumed by the illumination unit of the image capturing apparatus that does not need to irradiate infrared illumination.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-076222, filed May 2, 2022, which is hereby incorporated by reference herein in its entirety.

1. An image capturing control apparatus that controls a plurality of image capturing apparatuses, the plurality of image capturing apparatuses including irradiation units that irradiate infrared light, the image capturing control apparatus comprising:
a hardware processor; and
a memory for storing instructions to be executed by the hardware processor;
wherein, when the instructions stored in the memory are executed by the hardware processor, the image capturing control apparatus functions as:
setting unit configured to set power distributed to each of the plurality of image capturing apparatuses in accordance with a priority for each of the plurality of image capturing apparatuses; and
control unit configured to control the irradiation unit included in each of the plurality of image capturing apparatuses in accordance with the set power.

2. The image capturing control apparatus according to claim 1,
wherein the setting unit sets the power distributed to each of the plurality of image capturing apparatuses such that a total of the power distributed to the plurality of image capturing apparatuses is less than a total of required power in response to the total of the required power of the plurality of image capturing apparatuses exceeding a threshold.

3. The image capturing control apparatus according to claim 1,
wherein the setting unit performs setting such that power distributed to the irradiation unit of the image capturing apparatus having a high priority is increased.

4. The image capturing control apparatus according to claim 1,
wherein the setting unit performs setting such that a reduction rate of power distributed to the irradiation unit of the image capturing apparatus having a high priority is reduced.

5. The image capturing control apparatus according to claim 1,
wherein, when at least two image capturing apparatuses to which a same priority is set are present among the plurality of image capturing apparatuses, the control unit limits an output of the infrared light irradiated from the irradiation unit of each of the at least two image capturing apparatuses.

6. The image capturing control apparatus according to claim 1,
wherein the control unit stops capturing an image by an image capturing apparatus selected from the plurality of image capturing apparatuses in response to a total of required power of the plurality of image capturing apparatuses exceeding a threshold.

7. The image capturing control apparatus according to claim 1,
wherein, when the instructions stored in the memory are executed by the hardware processor, the image capturing control apparatus further functions as determination unit;
wherein the determination unit determines an image capturing apparatus to stop capturing an image among the plurality of image capturing apparatuses based on whether illuminance of a subject whose image is captured by each of the plurality of image capturing apparatuses exceeds a threshold; and
wherein the setting unit sets the power distributed to each of the plurality of image capturing apparatuses based on a difference between power consumption of the image capturing apparatus to stop capturing an image and a total power consumption obtained by summing power used for other than irradiation of the infrared light requested by the image capturing apparatus other than the image capturing apparatus to stop capturing an image among the plurality of image capturing apparatuses and the priority.

8. The image capturing control apparatus according to claim 7,
wherein the determination unit determines the image capturing apparatus to stop capturing an image among the plurality of image capturing apparatuses based on whether a subject of interest is captured in images captured by the plurality of image capturing apparatuses.

9. The image capturing control apparatus according to claim 1,
wherein the setting unit sets the priority for each of the plurality of image capturing apparatuses based on whether a subject of interest is captured in images captured by the plurality of image capturing apparatuses.

10. The image capturing control apparatus according to claim 7,
wherein, when the instructions stored in the memory are executed by the hardware processor, the image capturing control apparatus further functions as input unit;
wherein the input unit inputs the priority of capturing an image for each of the plurality of image capturing apparatuses; and
wherein the determination unit determines the image capturing apparatus to stop capturing an image among the plurality of image capturing apparatuses based on the priority of capturing an image for each of the plurality of image capturing apparatuses input by the input unit.

11. The image capturing control apparatus according to claim 10,
wherein the setting unit sets power distributed to the irradiation unit of each of the plurality of image capturing apparatuses based on the priority of capturing an image for each of the plurality of image capturing apparatuses input by the input unit.

12. The image capturing control apparatus according to claim 7,
wherein the determination unit determines an image capturing apparatus to stop capturing an image among the plurality of image capturing apparatuses based on whether each of the plurality of image capturing apparatuses includes the irradiation unit and whether illuminance of a subject whose image is captured by each of the plurality of image capturing apparatuses exceeds a threshold.

13. The image capturing control apparatus according to claim 1,
wherein the control unit performs control such that the irradiation unit included in each of at least two image capturing apparatuses among the plurality of image capturing apparatuses intermittently irradiates the infrared light.

14. The image capturing control apparatus according to claim 13,
wherein the control unit limits frame rates of the at least two image capturing apparatuses such that an image is captured while the irradiation unit irradiates the infrared light.

15. The image capturing control apparatus according to claim 13,
wherein the control unit controls an output of the irradiation unit included in each of the at least two image capturing apparatuses such that at least one irradiation unit among the irradiation units included in the at least two respective image capturing apparatuses does not irradiate the infrared light while one irradiation unit among the irradiation units included in the at least two respective image capturing apparatuses irradiates the infrared light.

16. The image capturing control apparatus according to claim 7,
wherein the determination unit determines whether a degree of overlap of an overlapping range with respect to an image capturing range of the one image capturing apparatus exceeds a threshold, in the overlapping range, a range in which the irradiation unit of one image capturing apparatus among the plurality of image capturing apparatuses irradiates the infrared light overlaps with a range in which the irradiation unit of another image capturing apparatus irradiates the infrared light; and
wherein the control unit limits an output of the irradiation unit of the one image capturing apparatus based on a result of the determination by the determination unit.

17. The image capturing control apparatus according to claim 7,
wherein, when the instructions stored in the memory are executed by the hardware processor, the image capturing control apparatus further functions as notification unit; and
the notification unit superimposes information indicating that an output of the irradiation unit of each of the plurality of image capturing apparatuses is limited on an image captured by each of the plurality of image capturing apparatuses and notifies an external device of the superimposed image when the total power consumption exceeds a threshold.

18. The image capturing control apparatus according to claim 7,
wherein, when the total power consumption does not exceed a threshold, the control unit performs control to maintain an output of the irradiation unit of each of the plurality of image capturing apparatuses.

19. An image capturing system, comprising:
a plurality of image capturing apparatuses that include image capturing unit that capture subjects and irradiation unit that irradiate infrared light; and
the image capturing control apparatus according to claim 1.

20. An image capturing control method that controls a plurality of image capturing apparatuses, the plurality of image capturing apparatuses including irradiation units that irradiate infrared light, the image capturing control method comprising:
setting power distributed to each of the plurality of image capturing apparatuses in accordance with a priority for each of the plurality of image capturing apparatuses; and
controlling the irradiation unit included in each of the plurality of image capturing apparatuses in accordance with the set power.

21. A non-transitory computer-readable storage medium storing instructions that, when executed by a computer, cause the computer to perform the image capturing control method comprising:
setting power distributed to each of the plurality of image capturing apparatuses in accordance with a priority for each of the plurality of image capturing apparatuses; and
controlling the irradiation unit included in each of the plurality of image capturing apparatuses in accordance with the set power.
